(19) United States
(12) Patent Application Publication
(10) Pub. No.: US 2013/0083522 A1
(43) Pub. Date: Apr. 4, 2013

(54) Light Fixture Using Light Emitting Diodes

(71) Applicants: Mark Turner Bowers, Johns Creek, GA (US); William Ernest Shank, Powder Springs, GA (US)

(72) Inventors: Mark Turner Bowers, Johns Creek, GA (US); William Ernest Shank, Powder Springs, GA (US)

(21) Appl. No.: 13/252,154

(22) Filed: Oct. 3, 2011

(51) Int. Cl. F21V 5/04; F21V 7/00; F21V 29/00; F21V 21/00

(52) U.S. Cl. 362/235; 362/249.02

(57) ABSTRACT

A lighting fixture with a unique modular design is described. The said lighting fixture is comprised of a thermally conductive structure that provides the heat sinking and mounting surfaces for the light emitting diodes, the power supply(s), and the lens optics. The lens optics are designed in such a way as to accommodate a variety of warehouse aisle geometries or cavity ratios.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The present invention generally relates to light fixtures based on light emitting diodes or LEDs used in commercial or industrial applications, for example high bay warehouse lighting. More specifically the invention accommodates various aisle geometries, can easily be adapted for future, more efficient light emitting diodes, and is less expensive to manufacture than currently available light fixtures.

### RELATED ART

Light fixtures are used for a variety of applications and are implemented using many different technologies. The present invention uses light emitting diodes or LEDs which is known in the industry as Solid State Lighting. There are many LED based light fixtures on the market and in development. This emerging technology is an enabler for the present invention. Currently high bay lighting is dominated by High Intensity Discharge or HID lights. These have the advantage of low cost and relatively good efficiency. The disadvantages include rapid and significant lumen depreciation, slow warm-up to reach full intensity, and issues with hot restrike. There is also limited development to improve the efficiency of HID technology. Finally, due to the point source nature of the lamp, it is difficult to direct the light precisely where it is needed. An emerging technology used in warehouse lighting is fluorescent lighting. Fluorescent light fixtures have the advantages of excellent lumen maintenance and low cost. Their disadvantages include poor performance at hot or cold temperatures and greatly reduced life with increased frequency of on-off cycles. Like with HID fixtures, it is also difficult to precisely direct the light from fluorescent fixtures.

Solid State Lighting is an emerging technology for general illumination applications. Though well known in the industry there are several aspects to the present invention that are unique. In general the light fixtures available on the market, regardless of technology, are “one size fits all”. Very little allowance has been made to tailor the light fixture to the specific application. U.S. Pat. No. 7,824,070 describes a very generic LED based light fixture. No allowance is made to easily modify the fixture for different quantities of LEDs. As LED technology improves and fewer LEDs are required this type of fixture must be re-designed to provide the same level of light output. Also, this type of fixture is not optimized for specific room geometry. For example, if a given fixture worked well for a warehouse aisle that was 10 feet wide by 20 feet high, it would not at all be optimal for an aisle that was 10 feet wide by 30 feet high. The lower portion of the vertical task surface would be dark, making visibility poor. If additional fixtures are added until this area was sufficiently illuminated, other areas of the vertical and horizontal task surfaces would be too bright, wasting energy and potentially causing eye strain.

Lighting standards in the United States are set by building codes and ANSI standards that in turn reference the Lighting Handbook, published by the Illuminating Engineering Society of North America (IESNA). The Lighting Handbook provides guidelines for illumination of various applications. For an industrial warehouse the 10^{th} edition calls for an average of 100 lux (10 fc) on the “horizontal task surface” and 50 lux (5 fc) on the “vertical task surface”. In the case of an industrial warehouse where a person or a forklift is present, the horizontal task surface is defined as 5 feet above the floor, presumably where the worker would need the light. The vertical task surface refers to the front of the shelving where documentation of the various products is present. The previous 9^{th} edition called out an average of 100 lux (10 fc) on both the horizontal and vertical task surfaces. Clearly the lighting industry was challenged to provide enough light with currently available fixtures and IESNA was compelled to lower the standards. Further, the Lighting Handbook requires that the illuminance on both the horizontal and vertical task surfaces to be uniform. Specifically they are looking for a ratio of maximum to minimum illuminance values as measured anywhere on a task surface to be less than or equal to 5:1. For example, if the peak illuminance at one point on the task surface is 150 lux then the minimum can be no less than 30 lux anywhere on that task surface.

The vast majority of high bay facilities are poorly lit and do not meet the Illuminating Engineering Society of North America (IESNA) minimum specs. This is not so much the fault of the architect or facilities manager as it is the population of available light fixtures. Because the light is not precisely directed where needed there is either too much light or too little light provided on a given task surface. U.S. Pat. No. 7,765,508 describes a fixture where the LEDs are angled to better distribute the light where needed. U.S. Pat. No. 7,665,862 is similar to U.S. Pat. No. 7,765,508 in that it relies on varying the angle of the LED to provide the proper light distribution. However, no allowance for varying aisle geometries is provided, this type of fixture would have to be redesigned.

U.S. Pat. No. 7,686,476 describes an LED based dock light that uses narrow and wide angle lenses to illuminate the inside of a cargo truck. However, no consideration is made for modularity, accommodating multiple room geometries, or illuminating the task surfaces through lens technology.

LED efficiency and light output is advancing at a very rapid pace. The currently available fixtures were designed for a specific LED efficiency in mind. In other words they were designed for what was available at the time, without much regard for future, more efficient LEDs. For the most part, the currently available fixtures will have to be redesigned to perform the same with more advanced LEDs. Or at a minimum the current through the LEDs will have to be reduced resulting in minimal fixture cost saving.

U.S. Pat. No. 7,946,727 describes a modular LED structure consisting of regular hexagons forming a planar array. Each hexagon is intended to incorporate a single LED that can be combined with other hexagons to form an array of LEDs. This Patent teaches us how to create a light engine from a plurality of hexagons, but makes no mention of modularity at the light fixture level. The present invention is very different from U.S. Pat. No. 7,946,727 in that the focus is at the fixture level and not the LED array level. The minimum configuration of the present invention includes the body, light engine, lens module, and power supply. U.S. Pat. No. 7,726,840 is similar to U.S. Pat. No. 7,946,727 in that it is focused on creating a larger array of LEDs from a smaller array. In the case of U.S. Pat. No. 7,726,840 we are taught to combine linear arrays of LEDs into a longer string. Again, very different from the modularity described in the present invention. Finally, U.S. Pat. No. 6,422,716 teaches us yet another way to construct an array of LEDs this time using identical square LED modules. In all cases, the present invention is very different from prior art due to the modular nature at the fixture level and the intended accommodation of future LED technology.

It is desirable to have a light fixture that precisely matches the application it is used for, in the case of the present invention, warehouse aisles. This new light fixture would direct the light precisely where it is needed, and meet relevant codes and specifications without wasting light. Further, this new fixture would easily adapt to various aisle geometries minimizing the number of fixtures required, while meeting relevant lighting specifications. Due to the pace of advancement in LED technology it would be desirable for the fixture to be modular in nature. This new fixture could easily be sub-divided allowing the use of the new LEDs and not require a costly redesign. To further save cost, this new fixture would minimize the number of components and combine functions wherever possible.

### SUMMARY OF THE DISCLOSURE

Generally, the present invention provides a new industrial light fixture that uses less power by directing the light only where it is needed, is easier and less costly to assemble, and can easily be modified to incorporate more efficient light emitting diodes as they become available. It is intended that all such features and advantages be included herein and that the scope of the present invention be protected by a set of claims.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 shows an isometric view of the entire fixture viewed from the bottom showing the reflector, the lens modules, the end plate, and the motion sensor lens.

FIG. 2 shows the entire fixture in a trimetric view from the top showing the top cover plate and the heat sink fins.

FIG. 3 shows the entire fixture viewed from the bottom showing the motion sensor lens, the bottom cover plate, and the lens modules.

FIG. 4 shows the entire fixture viewed from the top showing the heat sink fins.

FIG. 5 shows the entire fixture viewed from the end showing the end plate, the reflector, the motion sensor lens, and the lens modules.

FIG. 6 shows the entire fixture in exploded view.

FIG. 7 shows an electrical block diagram of the present invention.

FIG. 8 illustrates the cavity ratio concept of the invention. The view is looking down the length of a typical aisle in a warehouse.

FIGS. 9a and 9b show 2 alternate embodiments of the invention shown from the bottom illustrating the modular nature of the invention. FIG. 9a shows a fixture with 64 LEDs while FIG. 9b shows a fixture with 32 LEDs.

FIGS. 10a and 10b show the 2 alternate embodiments of FIGS. 9a and 9b respectively in electrical block diagram form, one with 64 LEDs and one with 32 LEDs, again illustrating the modular nature of the invention.

### REFERENCE NUMBERS

102 Body
104 Light Engine
106 Lens Module
108 Top Cover Plate
110 Bottom Cover Plate
112 End Plate
114 Power Supply
116 Motion Board
118 Motion Sensor Lens
120 Screw
122 Reflector
124 Heat Sink Fin
126 Screw Chase
128 Screw Boss

### DETAILED DESCRIPTION

The present invention generally pertains to a new type of light fixture using light emitting diodes (LEDs). This new light fixture has several advantages over existing light fixtures. One advantage is that it is easier and less costly to manufacture than existing fixtures due to the minimal number of parts. The primary structural element serves as the mounting body for other components, the thermal heat sink, encompasses the geometry for light distribution, and integrates a reflector. This new fixture is modular in nature and can be sub-divided to take advantage of newer more efficient LEDs, something existing fixtures cannot do. This new fixture also has the ability to work in a variety of warehouse aisle geometries by simply changing the LED lens modules. This is all described in detail below.

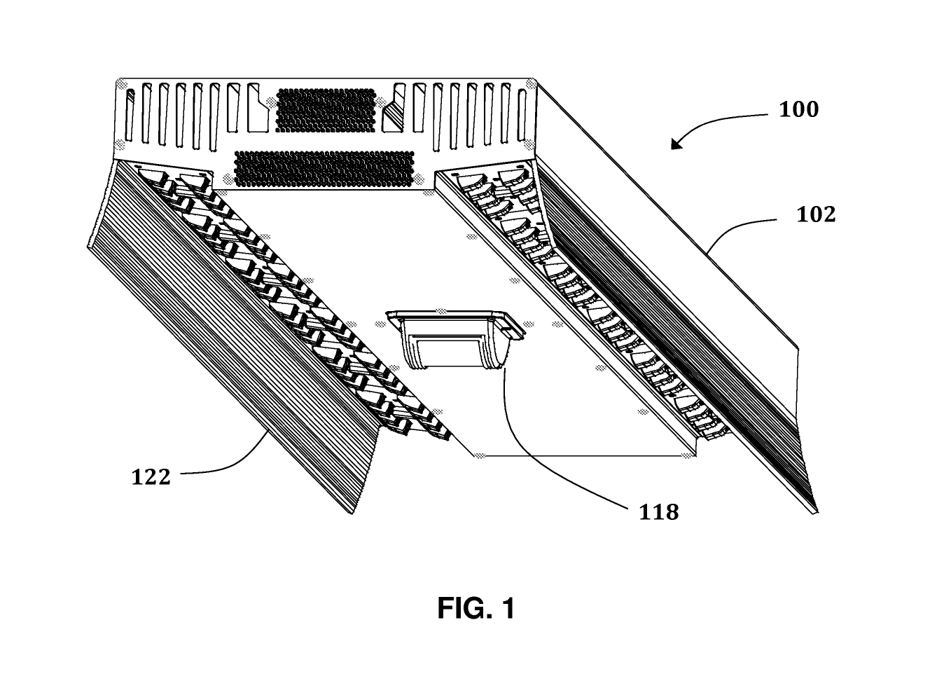

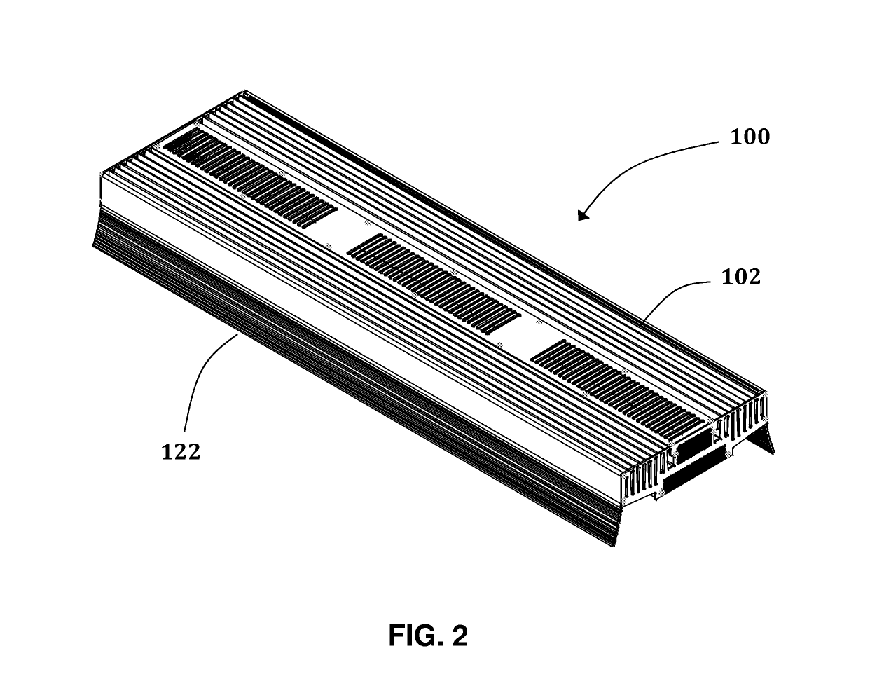

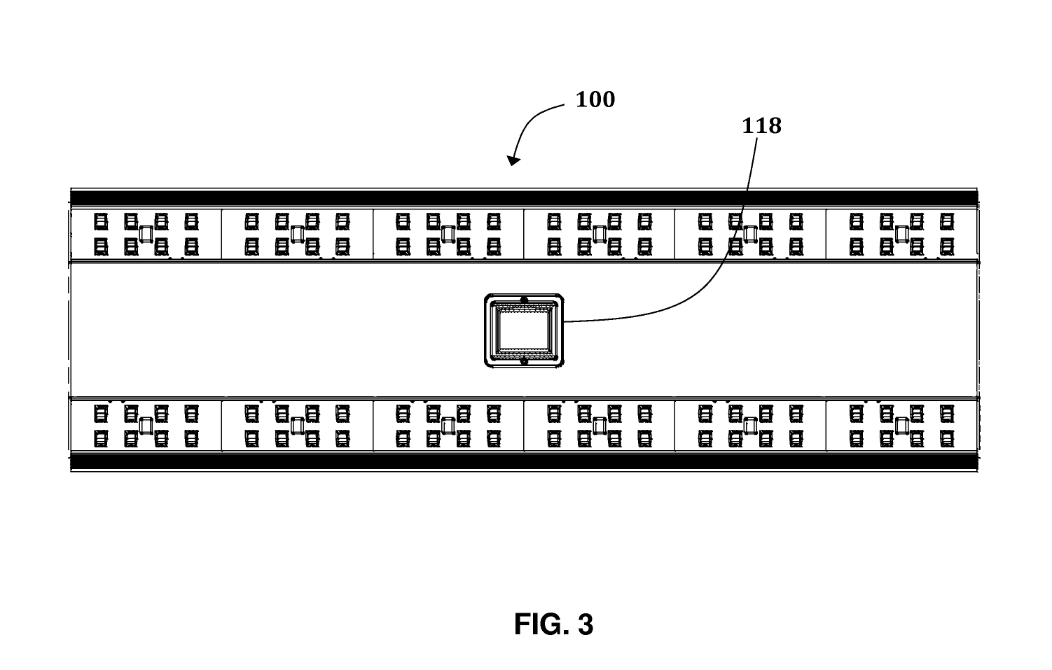

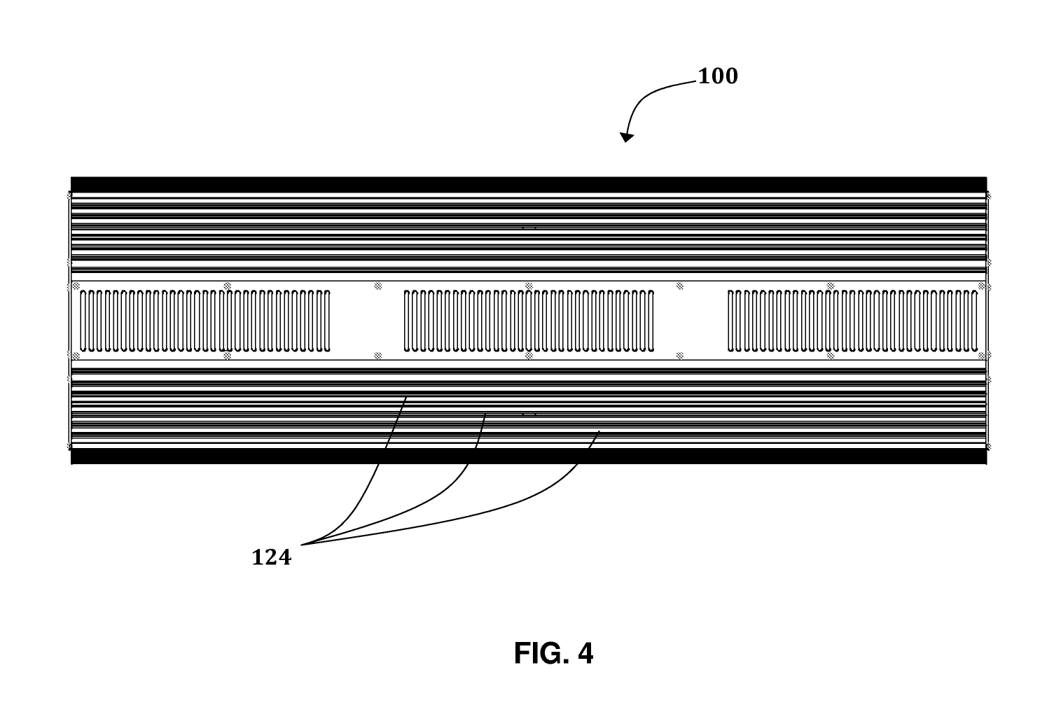

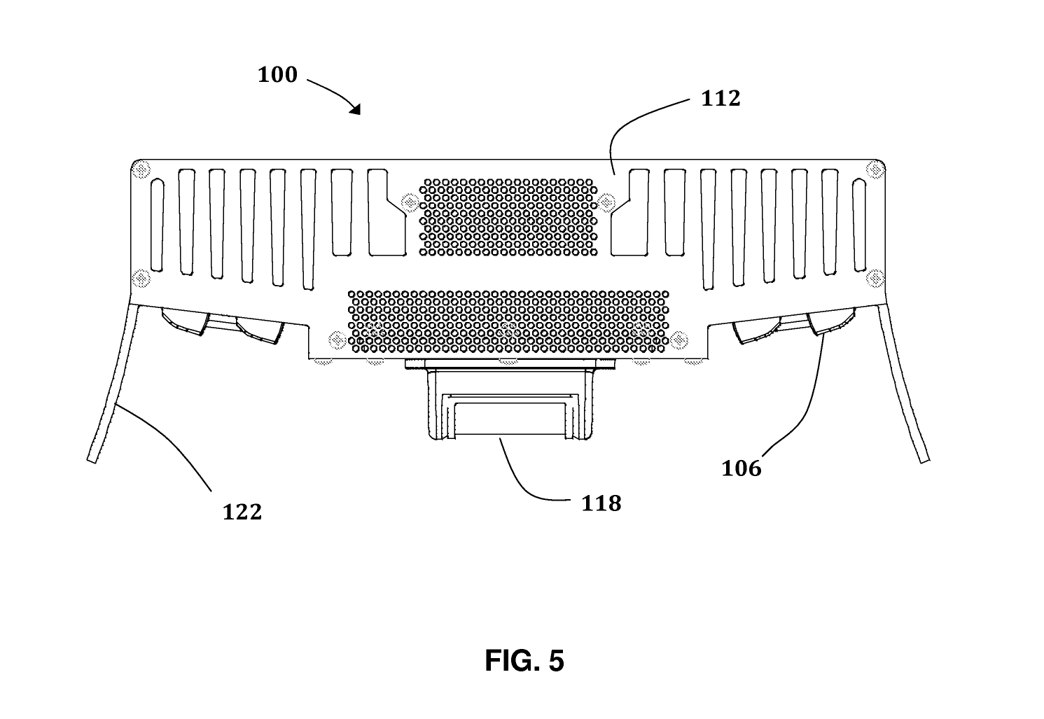

The construction and operation of this new fixture can be understood by referring to the Figures. FIGS. 1-5 show the complete fixture 100 from a variety of perspectives. Specifically, FIG. 1 shows the fixture 100 from a bottom isometric view showing the body 102, the reflector 122, and the motion sensor lens 118. FIG. 2 shows the fixture 100 in a top trimetric view showing the body 102, and the reflector 122. FIG. 3 shows the fixture 100 from a bottom view showing the motion sensor lens 118. FIG. 4 shows the fixture 100 from a top view showing the heat sink fins 124. FIG. 5 is a view from the end of the fixture 100 showing the end plate 112, the reflector 122, the motion sensor lens 118, and the lens module 106. Note that the angle of the surface on body 102, which the LED light engines 104 mount to, is nominally +/−7 degrees from the horizontal in this embodiment. This mounting angle in combination with the trade secret lens module 106 optics and the integrated reflector 122 provide the light distribution required to meet relevant specifications.

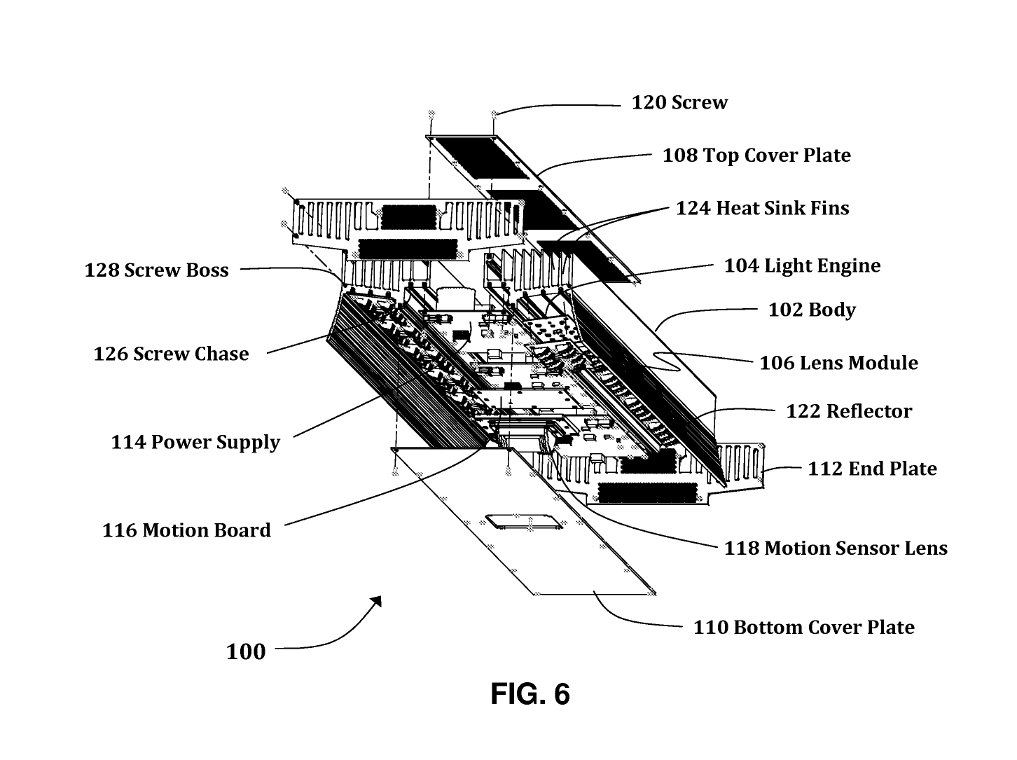

FIG. 6 is an exploded view of the fixture 100 from a bottom isometric perspective. The body 102 is the primary structural element in the fixture 100 and serves as the mounting surface for other elements in the fixture. Heat sink fins 124 and the reflector 122 are integral to the body 102, as are screw chases 126 and screw bosses 128. This body 102 would be an aluminum extrusion in the preferred embodiment and would be approximately thirty six (36) inches in length. Three (3) power supply boards 114 are attached to mating surfaces that are part of the body 102 using screws 120 or suitable fasteners. The screws 120 thread into screw chases 126. The power supply boards 114 are not central to the invention but essentially convert AC input power to a constant current suitable for driving an array of LEDs. Each power supply board 114 is approximately ten (10) inches long by four (4) inches wide. The input power, typically an AC voltage, would be supplied to each of these three (3) power supply boards using a suitable wiring harness. This wiring harness is not shown for clarity.

Still referring to FIG. 6, the motion sensor lens 118 and motion board 116 are attached to the bottom cover plate 110 using screws 120 or some other suitable fastener. Then the bottom plate assembly comprising the motion sensor lens 118, the motion board 116 and the bottom cover plate 110 is attached to the body 102 using screws 120 which thread into screw chases 126. The motion board 116 contains the motion sensor electronics. A wire cable with multiple conductors provides communication between the single motion board 116 and the three power supply boards 114. This cable is not shown in FIG. 6 for clarity.

Still referring to FIG. 6, there are six (6) light engines 104 and twelve (12) lens modules 106. Each light engine 104 contains sixteen (16) LEDs, thus there are ninety six (96) total LEDs per fixture 100 (16×6=96). Each lens module 106 covers eight (8) LEDs, hence the twelve (12) lens modules required (96/8=12). Screws 120 pass through the lens module 104 and light engine 102 and screw into the screw chases 126 provided in the body 102. Locating pins in the lens module 106 pass through close fit holes in light engine 104 to precisely align the lens module 106 to the individual LEDs on the light engine 104. Once screwed into place the thermal resistance between the light engine 104 and the body 102 is very low. This facilitates transferring the heat by conduction from the LEDs into the body 102 which contains integrated heat sink fins 124.

Still referring to FIG. 6 the top cover plate 108 is fastened into place using screws 120 that thread into screw chases 124 provided in body 102. Two (2) end plates 112 are screwed into place using screws 120 that thread into screw bosses 126 that are provided in body 102, thus completing assembly of the fixture 100. Note that in the preferred embodiment, the screws used to assemble the fixture would be such that only the manufacturer of the fixture could easily disassemble the fixture. For example, the head of the screw and the blade of the associated screwdriver could be of a shape not generally found on the open market. This eliminates user serviceable parts and eases safety compliance costs. As can be seen to those skilled in the art this new fixture is very simple in construction, requiring as little as one screwdriver to assemble, and less costly to produce than currently available fixtures.

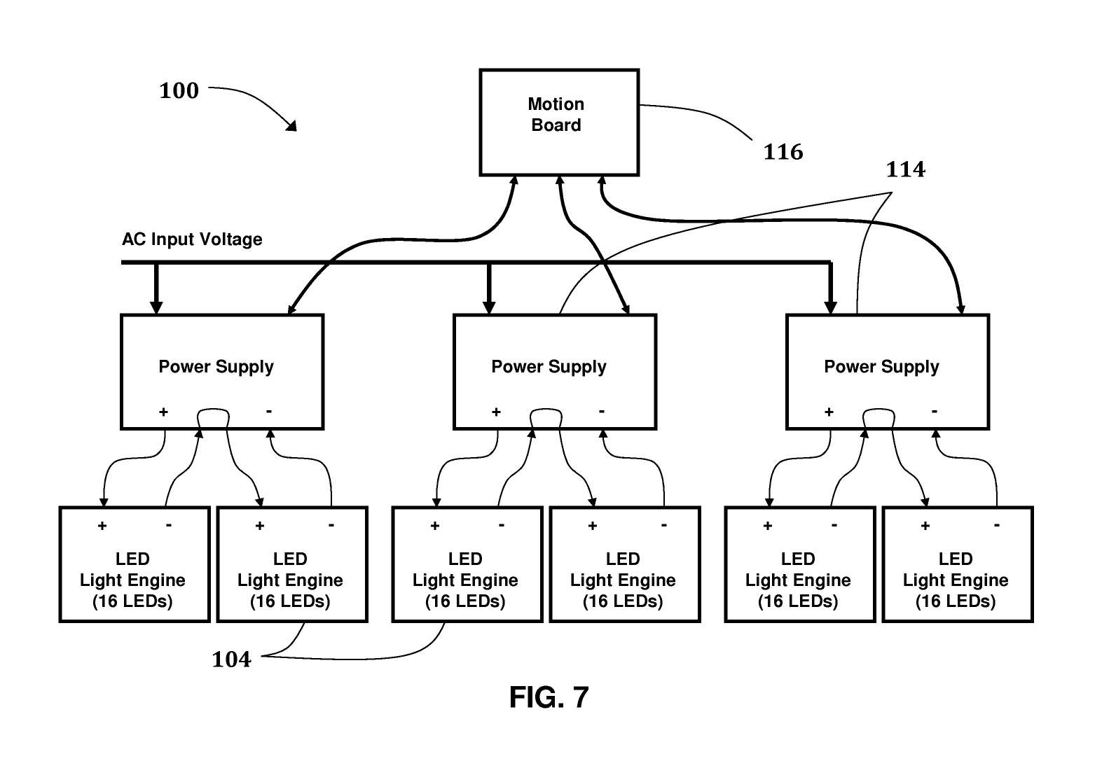

The operation of the fixture can be explained by referring to the electrical block diagram in FIG. 7. Power is supplied to the AC Input Voltage which activates the three (3) power supply boards 114. The motion board 116 detects motion through the motion sensor (not shown in FIG. 7). When an occupant is present in the aisle a signal is sent from the motion board 116 to the power supplies 114 sending a current through the LED light engines 104 thus turning the LEDs on. Each power supply 114 drives a total of thirty two (32) LEDs, divided into two (2) light engines 104 of sixteen (16) LEDs each. The thirty two (32) LEDs of the two (2) light engines are all wired in series as shown in FIG. 7. There are three (3) groups of thirty two (32) LEDs per fixture for a total of ninety six (96) LEDs. Each power supply drives a nominal 700 mA of current through each group of thirty two (32) LEDs. The details of the electronics are not central to the invention so no further details are provided. The operation described above is standard knowledge to those skilled in the art.

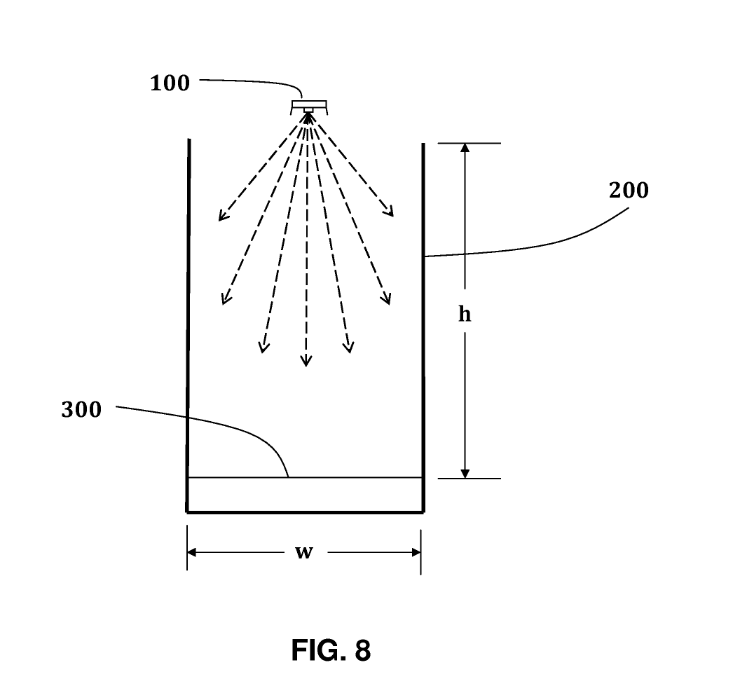

A significant advantage of this new fixture over currently available fixtures is illustrated with the help of FIG. 8. This diagram represents the aisle of a typical storage warehouse as viewed from one end. The light fixture 100 is positioned at the top of the aisle “cavity” and distributes light downward. In a warehouse environment light is required on both the horizontal task surface 300 and the vertical task surfaces 200. Typically products in warehouses are placed on shelves that are stacked vertically on racks. Operators in the warehouse must be able to read the labels on the products and any other documentation that might be present. As stated in the Related Art section there are well defined standards for illumination levels required in a warehouse environment. Unfortunately there is not a currently available product on the market that effectively illuminates these horizontal and vertical task surfaces AND can adapt to varying aisle geometry.

Again referring to FIG. 8, there is shown a horizontal dimension “w” and a vertical dimension “h”. The ratio of h to w is referred to as the “cavity ratio”. For example, if the light fixture is positioned 35 feet from the aisle floor and the horizontal task surface 300 is defined as 5 feet above the floor then the dimension h is equal to 30 feet. Assuming the aisle is 10 feet wide, the cavity ratio is defined as 30:10 or 3:1. Likewise if the vertical dimension was 20 feet with the same 10 foot wide aisle the cavity ratio would be 2:1. Warehouses vary greatly in aisle geometry and range from cavity ratios greater than 3:1 down to 1:1, and possibly less.

The present invention is designed in such a way that only the lens modules have to swapped out to accommodate different cavity ratios. The specifics of the lens design is kept as a trade secret but prototypes of both a 3:1 cavity ratio lens and a 2:1 cavity ratio lens have already been designed and simulated. Alternate cavity ratios such as 1:1, 1.5:1, and 2.5:1 have also been rationalized. The combination of the mounting angle of the light engines, the optics of the LED lens modules, and the integrated reflector allow the light fixture to meet relevant specifications.

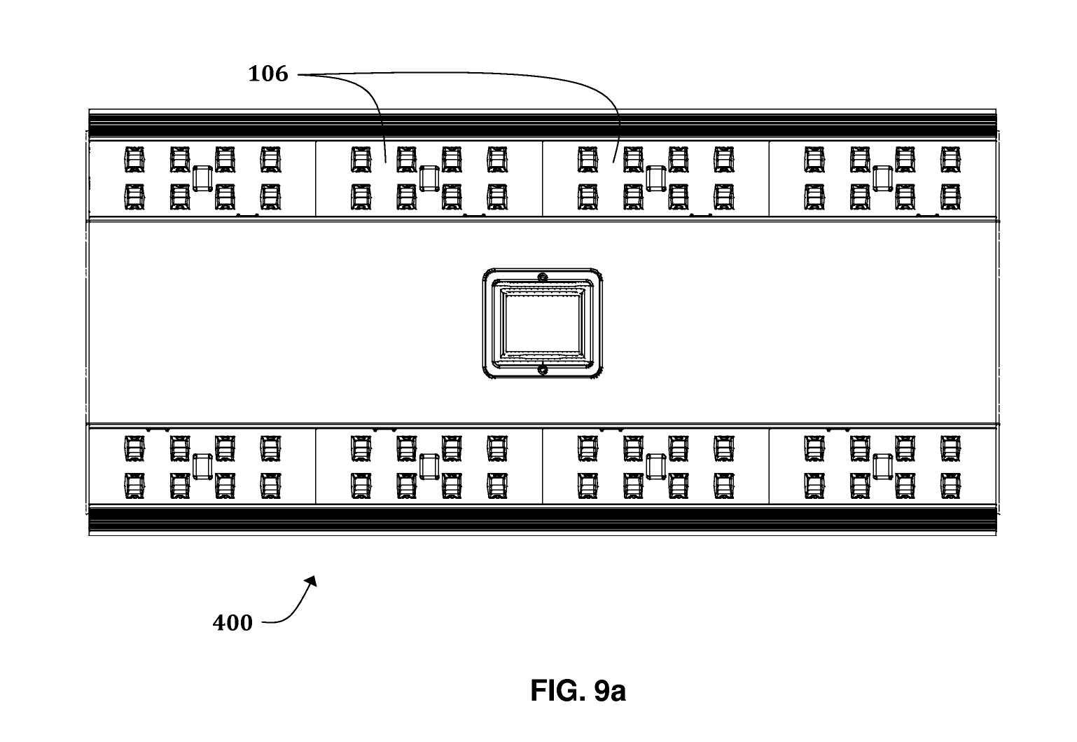

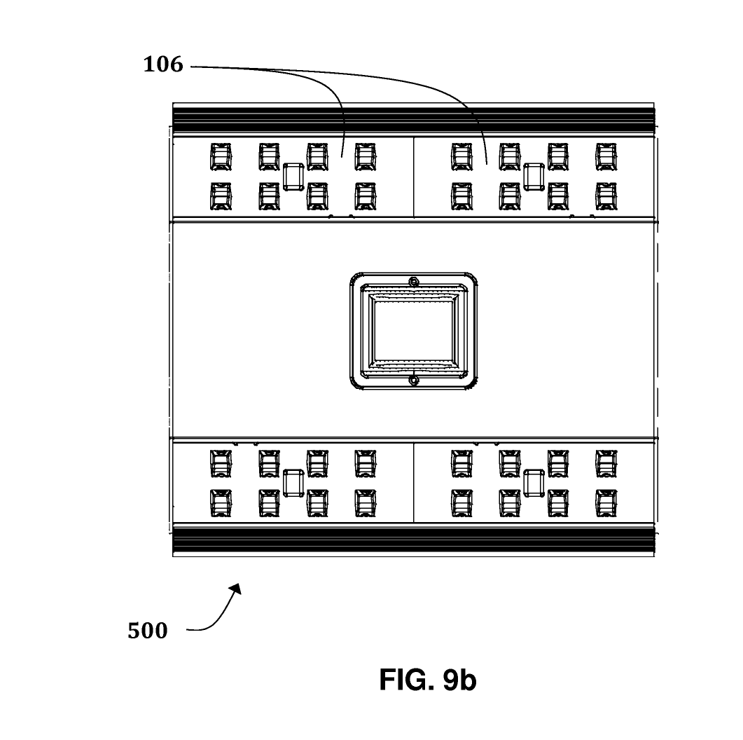

FIG. 9 shows 2 alternate embodiments of the new fixture that are central to the invention. Since the new fixture is modular in nature it is very easy to divide the fixture such that it performs the same with higher power, more efficient LEDs. FIG. 9a shows an embodiment that contains sixty four (64) LEDs. This is achieved by removing one third (⅓) of the extrusion length, deleting one power supply, and deleting two (2) light engines along with the associated four (4) lens modules. This leaves an extrusion of approximately twenty four (24) inches in length with two (2) power supplies, four (4) light engines, and eight (8) lens modules. Since the aluminum extrusion can be cut to any length by the manufacturer, varying the length of the extrusion is a very simple thing to do. Minor changes to the wiring harness, bottom plate, and top plate would be needed to accommodate this change.

Similarly, FIG. 9b shows another embodiment with only thirty two (32) LEDs. The extrusion is now cut to a length of approximately twelve (12) inches and contains one (1) power supply, two (2) light engines, and four (4) lens modules. This is the minimum configuration that can be realized with the currently designed hardware. However, the lens module has been designed in such a way that only two (2) lens modules are needed to completely realize the light pattern required. With a relatively minor re-design a fixture with only sixteen (16) LEDs could be realized that had the same light pattern as the original ninety six (96) LED fixture.

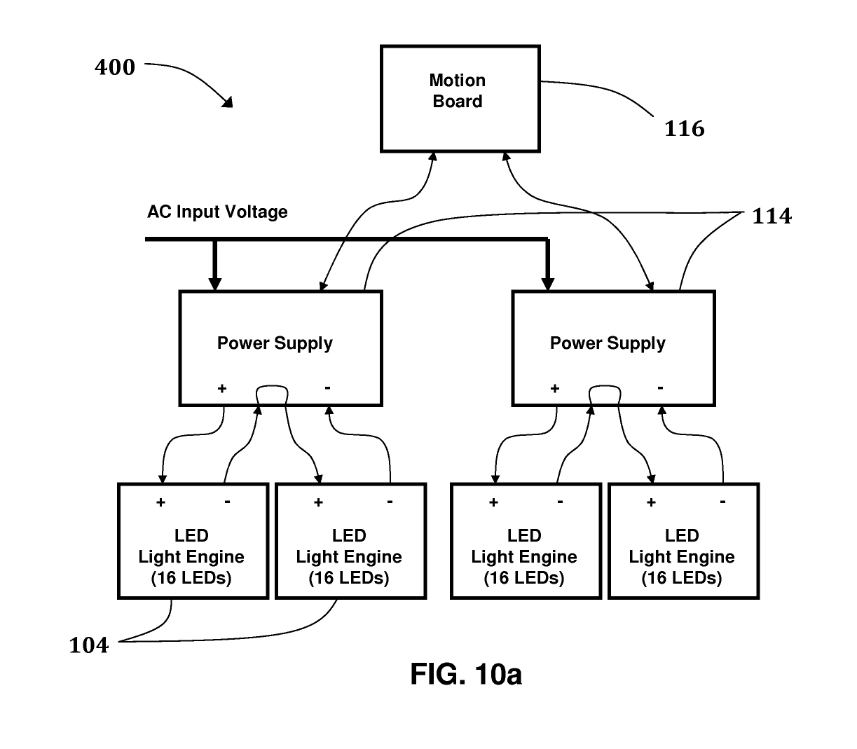

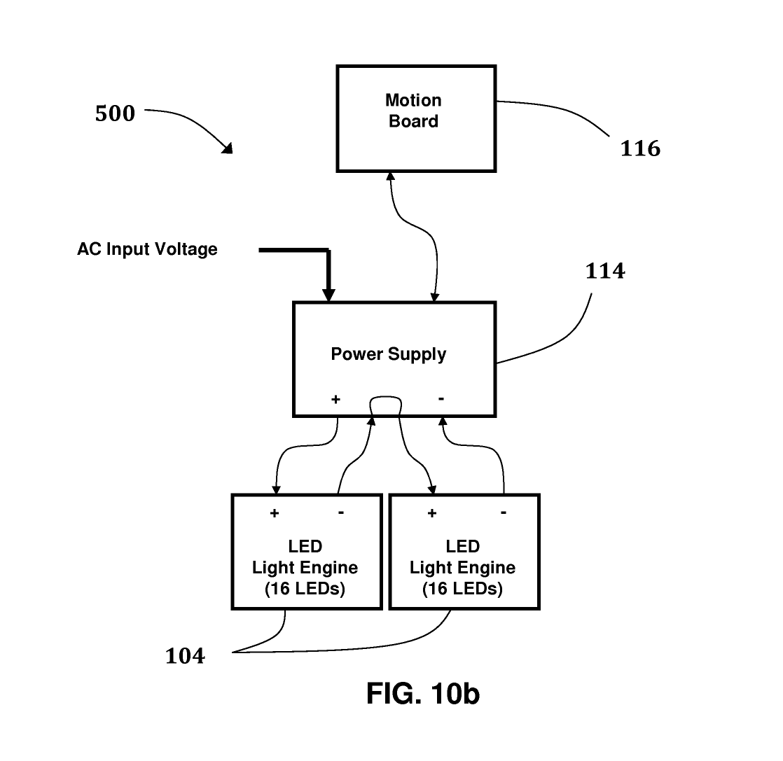

FIG. 10 shows the electrical block diagrams of the alternate embodiments shown in FIG. 9 and described above. FIGS. 10a and 10b shows how a sixty four (64) LED and thirty two (32) LED fixture could be realized respectively. It should be obvious to those skilled in the art that migrating from ninety six (96) LEDs to sixty four (64) LEDs to thirty two (32) LEDs is a very straightforward progression using the current components.

To further explain the concept above an example is provided. Suppose that currently available LEDs provide nominally 170 lumens of light when driven by 700 mA of current. It would follow that a fixture containing ninety six (96) LEDs would provide 16,320 lumens (170 lms×96) of light. As stated before, the pace of advancement in LED technology is very fast. Assume that in the not so distant future there exists a commercially available LED that puts out 255 lumens of light when driven by 700 mA of current. By simply reducing the number of LEDs from ninety six (96) to sixty four (64) and using this 255 lumen LED we can achieve the same performance with a sixty four (64) LED fixture as we did with our ninety six (96) LED fixture (255 lms×64 =16,320 lms). Further, if we had a 510 lumen LED at 700 mA we could produce a thirty two (32) LED fixture that would also perform the same as our ninety six (96) LED fixture (510 lms×32=16,320 lms). As can be seen by those skilled in the art, the cost savings associated with a sixty four (64) or thirty two (32) LED based fixture vs. the original ninety six (96) LED fixture are dramatic. Those savings are achieved without a major redesign of the fixture. Most components are re-used as is.

Obviously, advances in LED technology do not occur in these discrete steps. To accommodate smaller, incremental advances in LED technology the current output of the power supply can be adjusted by simply changing the value of a resistor. For example, if LEDs became available that provided 200 lumens of light at 700 mA the current output could be adjusted downward to achieve the same 170 lumens as before. This adjustment would not have the dramatic cost savings illustrated above but would have a positive effect on power consumption.

It should be further emphasized that the above-described embodiments of the present invention are merely possible examples of implementations and set forth for a clear understanding of the principles of the invention. Many variations, modifications, and combinations may be made to the above-described embodiments of the invention without departing substantially from the spirit and principles of the invention. All such modifications, combinations, and variations are intended to be included herein within the scope of this disclosure and the present invention and protected by the following claims.

1. A light fixture comprising:
a. a rigid structure that serves as the mounting body for other elements,
b. a plurality of light emitting diodes,
c. a means for attaching said light emitting diodes to said rigid structure,
d. one or more power supplies used to drive the light emitting diodes, whereby said light fixture is modular in nature and can be divided such that the light output pattern remains substantially the same.

2. The fixture of claim 1 wherein said rigid structure is an aluminum extrusion.

3. The fixture of claim 1 contains corresponding sets of power supplies and light emitting diodes such that the fixture can be sub-divided.

4. The fixture of claim 1 contains sets of lens modules that cover a specific number of light emitting diodes, such that fewer lens modules could be used and yet still retain the original light pattern.

5. A light fixture comprising:
a. a rigid structure that serves as the mounting body for other elements,
b. a plurality of light emitting diodes,
c. one or more lens modules that direct the light from said light emitting diodes,
d. a means for attaching and aligning said lens modules and the light emitting diodes to said rigid structure,
e. one or more power supplies used to drive the light emitting diodes, whereby the lens modules can be replaced by different lens modules that still create substantially the same illumination pattern on one or more surfaces for a different aisle geometry.

6. The fixture of claim 5 has angled surfaces that the light emitting diodes mount to directing the light into the aisle.

7. The fixture of claim 5 includes a reflector integrated into said rigid structure that helps direct the light from the light emitting diodes.

8. A light fixture comprising:
a. a rigid structure that serves as the mounting body for other elements,
b. a plurality of light emitting diodes,
c. a means for attaching said light emitting diodes to said rigid structure,
d. one or more power supplies used to drive the light emitting diodes, whereby said rigid structure combines the functionality of the heat sink, the structural element, the mounting body for other elements of said fixture, the geometry for mounting the light emitting diodes, and includes a reflecting element.

9. The fixture of claim 8 uses lens modules that cover a specific number of light emitting diodes that direct the light and also serve as the physical protection for said light emitting diodes.

10. The fixture of claim 8 wherein said rigid structure is an extrusion made from suitable material.

11. The fixture of claim 8 is assembled using fasteners that are difficult to remove by anyone but the manufacturer of said fixture thus enhancing the safety and cost of the fixture.
